(19) United States
(12) Patent Application Publication
(10) Pub. No.: US 2012/0039088 A1
(43) Pub. Date: Feb. 16, 2012

(54) DISPLAY DEVICE

(75) Inventors: CHAO-CHANG LEE, Tu-Cheng (TW); YUAN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/096,279

(22) Filed: Apr. 28, 2011

(30) Foreign Application Priority Data
Aug. 12, 2010 (CN) 201010251929.3

(51) Int. Cl. F21V 7/22

(52) U.S. Cl. 362/606

(57) ABSTRACT

A display device includes a housing and a display module received in the housing. The display module includes a light source and a light guide plate. The light guide plate includes a light input surface adjacent to the light source, a light output surface, and a bottom surface opposite to the light output surface. The light input surface connects the light output surface to the bottom surface. The housing includes an inner surface opposite to the bottom surface. A reflective element is formed on the inner surface of the housing to reflect the light emitting from the bottom surface of the light guide plate into the light guide plate.

### CROSS-REFERENCE TO RELATED APPLICATIONS

This application is related to one co-pending U.S. patent application, which is: application serial no. [to be determined], with Attorney Docket No. US35047 entitled “DISPLAY DEVICE”. Such application has the same assignee as the instant application and is concurrently filed herewith. The disclosure of the above-identified application is incorporated herein by reference.

### BACKGROUND

1. Technical Field

The present disclosure relates to display devices, and more particularly, to a display device having a reflective element.

2. Description of Related Art

A display device includes a housing and a display module fixed in the housing. The display module includes a light source, a light guide plate, a diffusion sheet, a display panel, a reflecting sheet, and a fixing frame to fix the above-mentioned components. The diffusion sheet and the display panel are stacked on the light guide plate in that order. The reflecting sheet is placed below the light guide plate, and sandwiched between the bottom surface of the fixing frame and the light guide plate, such that the reflecting sheet can reflect the light emitting from the bottom surface of the light guide plate to improve the efficiency of utilization of light energy. However, the assembly process of the display device is complicated, and the display device is relatively thick because too many components are stacked together.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a display device including a top housing, a bottom housing, and a display module.

FIG. 2 is an isometric view of the display device of FIG. 1 in which the top housing is omitted.

FIG. 3 is an exploded, isometric view of the display device of FIG. 1 in which the top housing is omitted.

### DETAILED DESCRIPTION

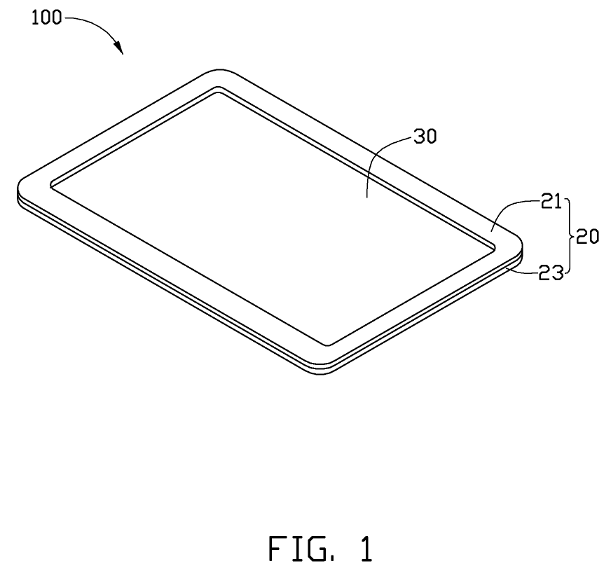

Referring to FIG. 1, an embodiment of a display device 100 used, for example, in a portable computer or a mobile phone, includes a housing 20 and a display module 30 fixed in the housing 20.

The housing 20 includes a top housing 21 and a bottom housing 23. The top housing 21 and the bottom housing 23 are fixed together and cooperatively define a receiving space for the display module 30.

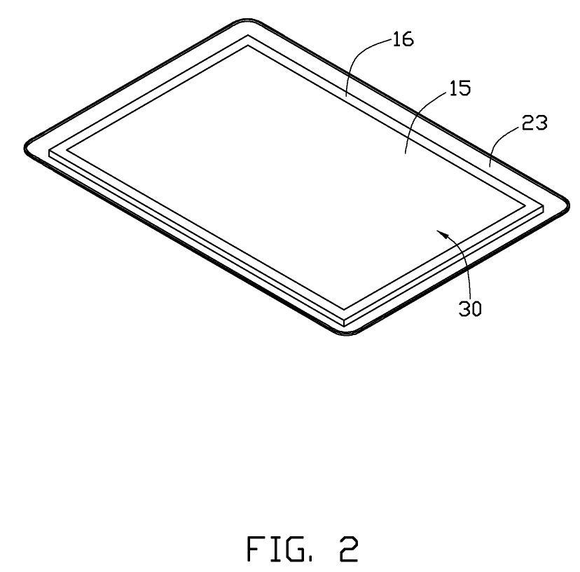

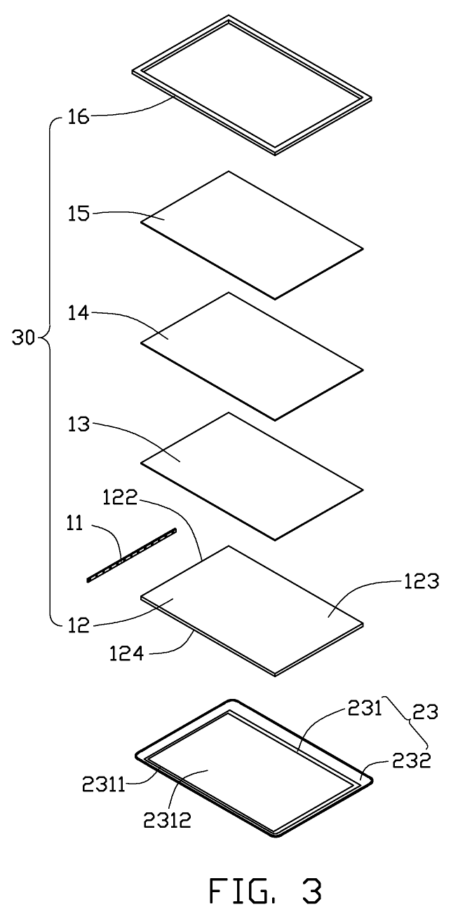

Referring to FIGS. 2 and 3, the display module 30 includes a light source 11, a light guide plate 12, a prism sheet 13, a diffusion sheet 14, a display panel 15, and a fixing frame 16.

The light guide plate 12 includes a light input surface 122, a light output surface 123, and a bottom surface 124. The light input surface 122 is adjacent to the light output surface 123, and connects the light output surface 123 to the bottom surface 124. The light output surface 123 is opposite to the bottom surface 124. The light source 11 is one or more light emitting diodes (LED) in this embodiment, and placed beside the light input surface 122 of the light guide plate 12. The light emitting from the light source 11 passes through the light input surface 122 and enters the light guide plate 12, and then one part of the light emits from the light output surface 123 to the display panel 15, and the other part of the light emits from the bottom surface 124. The prism sheet 13, the diffusion sheet 14, and the display panel 15 are stacked on the light guide plate 12 in that order. The fixing frame 16 fixes the light source 11, the light guide plate 12, the prism sheet 13, the diffusion sheet 14, and the display panel 15 together, and is securely connected to the bottom housing 23. In the illustrated embodiment, the fixing frame 16 is adhered to the bottom housing 23 with glue. In an alternative embodiment, other fixing methods can be employed to fix the display module 30 to the bottom housing 23, such as using screws.

The bottom housing 23 includes a base 231 and a sidewall 232. The base 231 includes an inner surface 2311 opposite to the bottom surface 124 of the light guide plate 12. The sidewall 232 extends from a periphery of the base 231. A reflective element 2312 is formed on the inner surface 2311. The reflective element 2312 is configured to reflect the light emitting from the bottom surface 124 into the light guide plate 12, such that the efficiency of utilization of light energy is improved.

In one embodiment, the reflective element 2312 is a reflective coating coated on the inner surface 2311. The reflective coating is a metal coating with high reflectivity. It should be appreciated that the reflective coating can be made of gold, silver, aluminum, or copper. In an alternative embodiment, the reflective coating may also be made of non-metal material, such as titanium dioxide.

In another embodiment, the reflective element 2312 is a reflective film adhered to the inner surface 2311. The reflective film may be a metal film with high reflectivity. It should be appreciated that the reflective film can be made of gold, silver, aluminum, or copper. In an alternative embodiment, the reflective film may also be made of non-metal material, such as titanium dioxide.

The reflective element 2312 can be attached to the bottom surface 124, or be spaced from the bottom surface 124.

Since the reflective element 2312 is formed on the inner surface 2311, a special reflecting sheet located opposite to the bottom surface 124 of the light guide plate 12 can be omitted, such that the display device 100 has relatively fewer components, thereby reducing manufacturing costs of the display device 100 and having a simpler assembly process. Additionally, the reflective element 2312 is formed in the bottom housing 23 directly, and does not occupy much space, thus the display device 100 may easily employ a thinner structure.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A display device, comprising:
a display module, the display module comprising a light source and a light guide plate, wherein the light guide plate comprises a light input surface adjacent to the light source, a light output surface, and a bottom surface opposite to the light output surface, the light input surface connects the light output surface to the bottom surface; and
a housing, the housing comprising an inner surface opposite to the bottom surface of the light guide plate, wherein the display module is received in the housing, and a reflective element is formed on the inner surface to reflect the light emitting from the bottom surface into the light guide plate.

2. The display device of claim 1, wherein the reflective element is a reflective coating coated on the inner surface.

3. The display device of claim 2, wherein the reflective coating is made of gold, silver, aluminum, or copper.

4. The display device of claim 2, wherein the reflective coating is made of titanium dioxide.

5. The display device of claim 1, wherein the reflective element is a reflective film adhered to the inner surface.

6. The display device of claim 5, wherein the reflective film is a metal film.

7. The display device of claim 6, wherein the metal film is made of gold, silver, aluminum, or copper.

8. The display device of claim 5, wherein the reflective film is made of titanium dioxide.

9. The display device of claim 1, wherein the light source is one or more light emitting diodes.

10. The display device of claim 1, wherein the housing comprises a top housing and a bottom housing fixed to the top housing, the top housing and the bottom housing cooperatively define a receiving space to receive the display module, and the display module is fixed to the bottom housing.
